(19) United States
(12) Patent Application Publication
(10) Pub. No.: US 2013/0148672 A1
(43) Pub. Date: Jun. 13, 2013

(54) METHOD OF PERFORMING IP FRAGMENTATION AND RELATED WIRELESS NETWORK SYSTEM

(71) Applicant: Tsung-Yo Cheng, New Taipei City (TW)

(72) Inventor: Tsung-Yo Cheng, New Taipei City (TW)

(73) Assignee: ACER INCORPORATED, New Taipei City (TW)

(21) Appl. No.: 13/365,231

(22) Filed: Feb. 2, 2012

(30) Foreign Application Priority Data
Dec. 8, 2011 (TW) 100145249

(51) Int. Cl. H04L 29/06

(52) U.S. Cl. 370/474

(57) ABSTRACT

A wireless network system includes a transmitting end and a receiving end which adopt a specific communication protocol for data transmission. At the transmitting end, a plurality of data packets are merged into a data packet string, which is then segmented into a plurality of sub data packets according to a maximum transmission unit of the specific communication protocol. The plurality of sub data packets are then transmitted to the receiving end for packet reassembly.

### BACKGROUND OF THE INVENTION

1. Field of the Invention

The present invention is related to a method of performing IP fragmentation and a related wireless network system, and more particularly, to a method of performing IP fragmentation and a related wireless network system capable of improving data throughput.

2. Description of the Prior Art

Various network applications become more and more widespread with rapid development in technology. Electronic devices, including desktop computers, notebook computers, personal digital assistants (PDAs) or smart phones, may be used for accessing the Internet. In a wireless network system, various communication protocols may be adopted for data intercommunication between a transmitting end and a receiving end. To ensure the accuracy of data transmission, the maximum size of each transmitted data packet should not exceed the maximum transmission unit (MTU) of the adopted communication protocol.

FIG. 1 is a function diagram of a prior art wireless network system 100. FIG. 2 is a diagram illustrating the prior art wireless network system 100 during data transmission using a specific communication protocol. The transmitting end of the wireless network system 100 includes a segmentation unit 10. The receiving end of the wireless network system 100 includes a reassembly unit 20. PK1-PK3 represent data packets of varying sizes.

If the size of the data packet PK1 is equal to the maximum transmission unit MTU of the specific communication protocol, the data packet PK1 may be transmitted directly from the transmitting end to the receiving end with 100% utilization percentage of the transmission unit.

If the size of the data packet PK2 is larger than the maximum transmission unit MTU of the specific communication protocol, the prior art segmentation unit 10 is configured to perform IP segmentation on the data packet PK2 so that two smaller sub data packets PK21′ and PK22′ maybe transmitted from the transmitting end to the receiving end. In other words, the data packet PK2 requires two transmissions and the utilization percentage of the transmission unit may not be 100% when transmitting the sub data packet PK22′.

If the size of the data packet PK3 is smaller than the maximum transmission unit MTU of the specific communication protocol, the data packet PK3 may be transmitted directly from the transmitting end to the receiving end, but the utilization percentage of the transmission unit may not be 100%.

In the prior art, if the segmentation unit 10 of the transmitting end performs IP fragmentation too often, the reassembly unit 20 of the receiving end needs to spend more resources for reassembling the sub data packets. Meanwhile, the utilization percentage of the transmission unit may not be 100% if the size of the data packet being transmitted is not equal to the maximum transmission unit of the specific communication protocol, thereby wasting network resources.

### SUMMARY OF THE INVENTION

The present invention provides a method of performing IP fragmentation in a wireless network system. The method includes providing a data packet string by merging a plurality of data packet at a transmitting end of the wireless network system; segmenting the data packet string into a plurality of sub data packets according to a maximum transmission unit of a communication protocol adopted by the wireless network system; and transmitting the plurality of sub data packets from the transmitting end of the wireless network system to a receiving end of the wireless network system.

The present invention also provides a wireless network system which performs IP fragmentation and includes a transmitting end and a receiving end. The transmitting end includes a merging unit configured to merge a plurality of data packet into a data packet string; and a segmenting unit configured to segment the data packet string into a plurality of sub data packets according to a maximum transmission unit of a communication protocol adopted by the wireless network system. The receiving end includes a reassembling unit configured to reassemble the plurality of sub data packets received from the transmitting end.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function diagram of a prior art wireless network system.

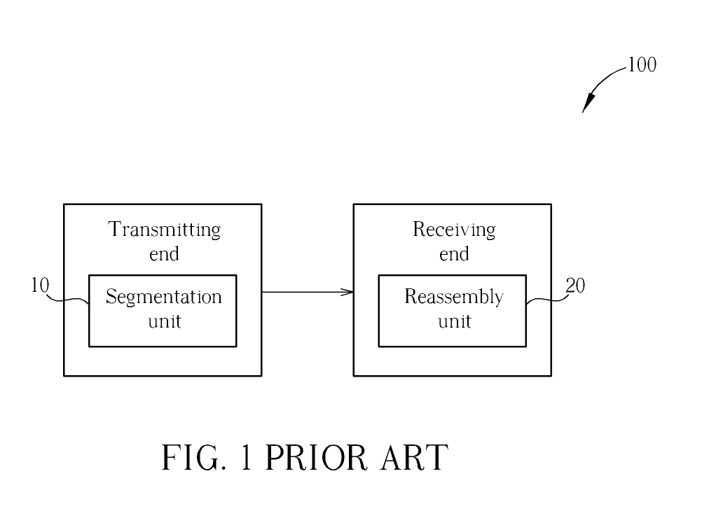

FIG. 2 is a diagram illustrating the prior art wireless network system during data transmission using a specific communication protocol.

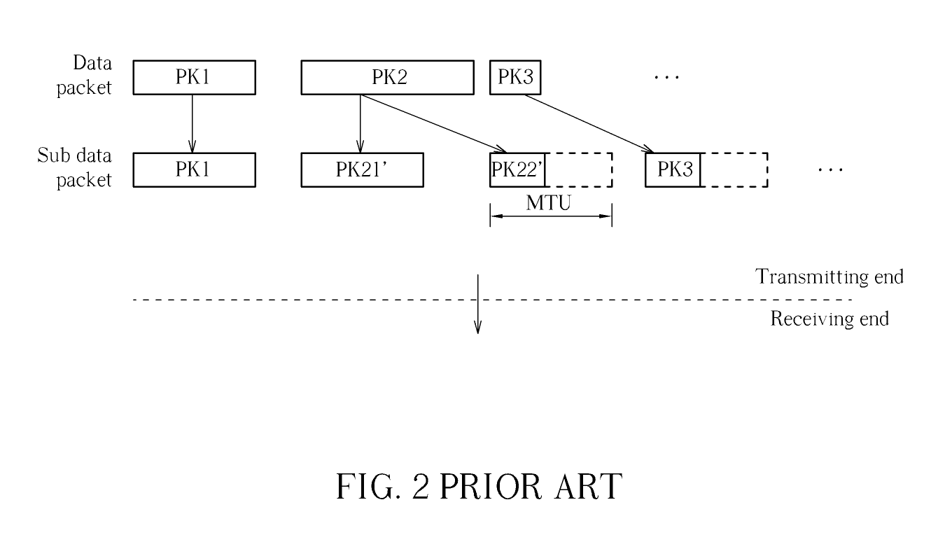

FIG. 3 is a function diagram of a wireless network system according to the present invention.

FIG. 4 is a diagram illustrating the wireless network system during data transmission using a specific communication protocol.

### DETAILED DESCRIPTION

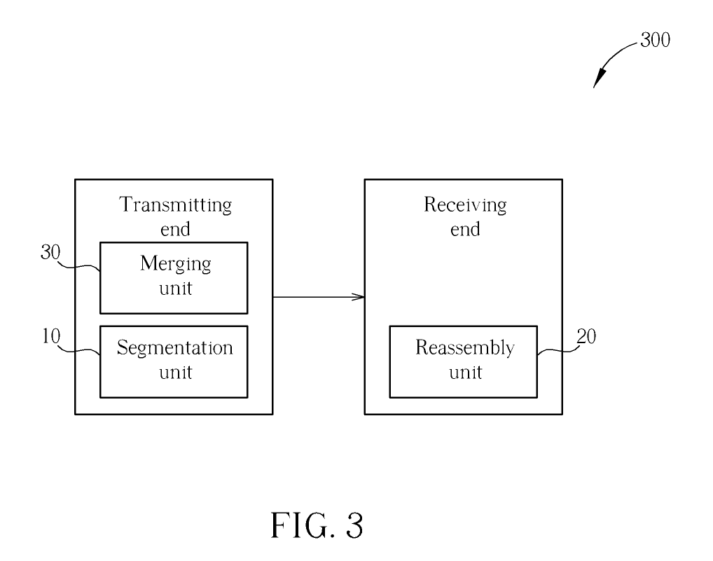

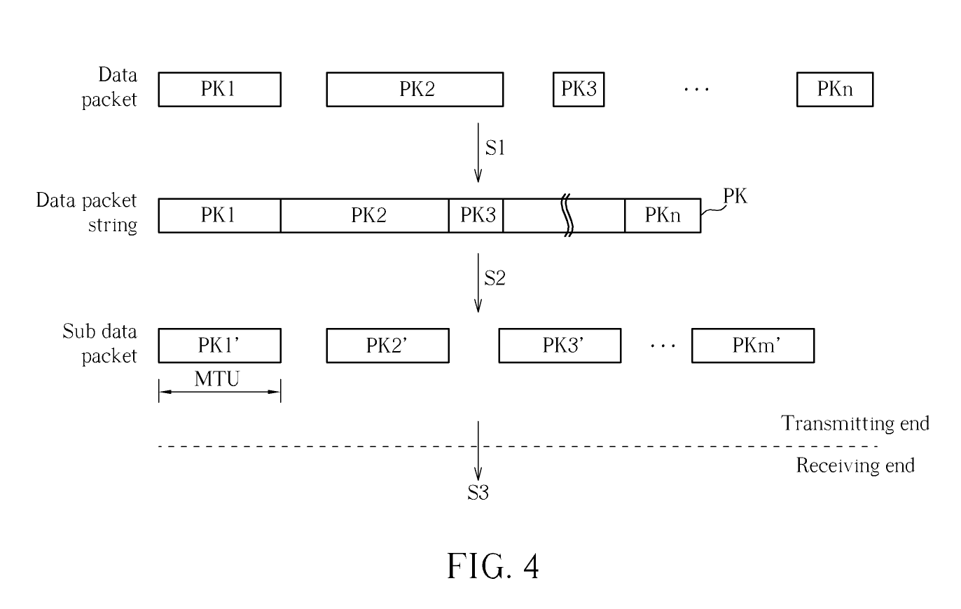

FIG. 3 is a function diagram of a wireless network system 200 according to the present invention. FIG. 4 is a diagram illustrating the wireless network system 200 during data transmission using a specific communication protocol. In an embodiment of the present invention, the wireless network system 200 may operate according to a multi-layered OSI (open system interconnection) structure. From bottom to top, Layer 1-Layer 7 sequentially include physical layer, data link layer, network layer, transport layer, session layer, presentation layer, and application layer. The wireless network system 200 includes a transmitting end and a receiving end which may be two different layers of the same user equipment (UE), two different layers of the same base station (BS), or a specific layer of a user equipment and a specific layer of a base station, respectively.

In the wireless network system 200, the transmitting end and the receiving end may adopt Ethernet protocol, Token-Ring protocol, fiber distributed data interface (FDDI) protocol, transmission control protocol (TCP), or user datagram protocol (UDP).

In the present invention, the transmitting end of the wireless network system 200 includes a segmentation unit 10 and a merging unit 30. The receiving end of the wireless network system 200 includes a reassembly unit 20. PK1-PKn represent data packets of varying sizes, such as application packets, protocol packets or QoS (quality of service) packets.

As depicted in FIG. 4, even if the sizes of the data packets PK1-PKn may be smaller than, equal to or larger than the maximum transmission unit MTU of the specific communication protocol, the merging unit 30 is configured to merge the data packets PK1-PKn into a data packet string PK (represented by an arrow S1). The segmentation unit 10 is then configured to provide a plurality of sub data packets PK1-PKm′ by performing IP segmentation on the data packet string PK (represented by an arrow S2). The reassembly unit 20 may perform data reconstruction at the receiving end (represented by an arrow S3).

The present invention may increase the utilization percentage of the transmission unit. If the size of the data packet string PK is equal to an integral multiple of the maximum transmission unit MTU, the sub data packets PK1′-PKm′ each having a size equal to the maximum transmission unit MTU may be transmitted with 100% utilization percentage of the transmission unit. If the size of the data packet string PK is not equal to an integral multiple of the maximum transmission unit MTU, only the sub data packet PKm′ is smaller than the maximum transmission unit MTU. Therefore, other sub data packets may be transmitted with 100% utilization percentage of the transmission unit, thereby increasing the overall utilization percentage of the transmission unit.

In conclusion, the present invention may perform IP fragmentation without lowering the overall utilization percentage of the transmission unit. Therefore, the wireless network system may transmit data more efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of performing IP fragmentation in a wireless network system, comprising:
providing a data packet string by merging a plurality of data packet at a transmitting end of the wireless network system;
segmenting the data packet string into a plurality of sub data packets according to a maximum transmission unit of a communication protocol adopted by the wireless network system; and
transmitting the plurality of sub data packets from the transmitting end of the wireless network system to a receiving end of the wireless network system.

2. The method of claim 1, further comprising:
reassembling the plurality of sub data packets at the receiving end of the wireless network system.

3. The method of claim 1, wherein a size of each sub data packet does not exceed the maximum transmission unit.

4. The method of claim 1, wherein the plurality of sub data packets are equal in size.

5. A wireless network system which performs IP fragmentation, comprising:
a transmitting end, comprising:
a merging unit configured to merge a plurality of data packet into a data packet string; and
a segmenting unit configured to segment the data packet string into a plurality of sub data packets according to a maximum transmission unit of a communication protocol adopted by the wireless network system; and
a receiving end, comprising:
a reassembling unit configured to reassemble the plurality of sub data packets received from the transmitting end.
